(19) United States
(12) Patent Application Publication
(10) Pub. No.: US 2025/0198454 A1
(43) Pub. Date: Jun. 19, 2025

(54) BEARING ARRANGEMENT FOR A ROTATING COMPONENT OF A WIND TURBINE

(71) Applicant: Nordex Energy SE & Co. KG, Hamburg (DE)

(72) Inventor: Martin Harich, Tornesch (DE)

(21) Appl. No.: 18/937,945

(22) Filed: Nov. 5, 2024

(30) Foreign Application Priority Data
Dec. 18, 2023 (EP) 23217477.1

(51) Int. Cl. F16C 23/08; F16C 19/38

(52) U.S. Cl. CPC F16C 23/08; F16C 19/38; F16C 2360/31

(57) ABSTRACT

A bearing arrangement for a rotating component of a wind turbine includes a first roller bearing, a second roller bearing and a rotating component defining a rotational axis. The rotating component is supported by the first roller bearing and the second roller bearing, and a stationary component supports the first roller bearing and the second roller bearing. A pretensioning device is configured such that, upon actuation, the pretensioning device causes a resulting force onto a first bearing inner ring or a first bearing outer ring to adjust the pretension of the bearing arrangement, wherein the resulting force is unevenly distributed over a circumference of the first roller bearing with respect to the rotational axis.

### CROSS-REFERENCE TO RELATED APPLICATIONS

This application claims priority of European patent application no. 23217477.1, filed Dec. 18, 2023, the entire content of which is incorporated herein by reference.

### TECHNICAL FIELD

The disclosure relates to a bearing arrangement for a rotating component of a wind turbine.

### BACKGROUND

Wind turbines with wind turbine rotor blades (hereinafter also referred to as rotor blades) are well known in the prior art and are used to convert wind energy into electrical energy.

In wind turbines, there are direct drive concepts in which the rotational motion of the rotor hub is transmitted directly and immediately to a rotating shaft of a generator. Alternatively, there are drive train concepts in which a gearbox is connected between the rotor hub and the generator, wherein the gearbox is connected to the rotor hub via a rotor shaft.

A technical challenge for wind turbines of this type, which are configured for a power range of several megawatts of electrical power, for example, is the provision of a bearing arrangement that meets high technical requirements, such as high bending stiffness, a clearance-free bearing arrangement, low-wear kinematics and the simplest possible assembly combined with high cost-efficiency.

It is known to use roller bearings, for example, tapered roller bearings, to support rotating components of wind turbines, like the rotor shaft. Some roller bearings such as tapered roller bearings are configured to work in pairs. These tapered roller bearings are pretensioned, which means that even with no external load they have a minimum load to allow all rolling elements of the roller bearings to interact with the raceways. This is advantageous in terms of load distribution and contributes to an improved lifetime. This pretension should be kept within narrow limits so that, on the one hand, the positive effect of all rolling elements being in contact with the raceways is ensured and, on the other hand, the roller bearings are not overloaded.

### SUMMARY

An object underlying the disclosure is to develop a concept for a bearing arrangement to support a rotating element of a wind turbine, which contributes to an efficient adjustment of the level of pretension.

A bearing arrangement is disclosed, in particular a rotor bearing arrangement, for a rotating component of a wind turbine, in particular for a rotor shaft. The bearing arrangement includes a first roller bearing and a second roller bearing. The bearing arrangement includes the rotating component having a rotational axis, wherein the rotating component is supported by the first roller bearing and the second roller bearing. A stationary component is provided, in particular a bearing housing, for supporting the first roller bearing and the second roller bearing. The first roller bearing, the second roller bearing, the rotating component and the stationary component are arranged to form a pretension circuit. The first roller bearing includes a first bearing inner ring, a first bearing outer ring and rolling elements arranged between the first bearing inner ring and the first bearing outer ring. The bearing arrangement includes a pretensioning device being configured such that, upon actuation, the pretensioning device causes a resulting force onto the first bearing inner ring or the first bearing outer ring to adjust the pretension of the bearing arrangement, wherein the resulting force is unevenly distributed over a circumference of the first roller bearing with respect to the rotational axis.

As indicated above, a predetermined pretension of the bearing arrangement is necessary and is initially set, for example, during assembly or installation in the field. For example, a mean value of pretension is used as a reference value. For different reasons, an adjustment of the pretension can be necessary, for example due to wear. Therefore, it is necessary and advantageous to control and adjust the level of pretension, not only during the production/mounting, but even during operation/maintenance.

The pretension is applied by the pretensioning device by moving/deforming parts (for example, bearing inner or outer ring). Thereby, an associated friction has to be overcome. This friction is mainly influenced by radial forces which are part of the load acting on the bearing arrangement and in particular on the first roller bearing. These radial forces are mainly associated with a static load which is caused by the rotor weight. Preferably, the pretensioning device acts on the stationary ring of the first roller bearing, either the outer ring or the inner ring.

The disclosure takes into account that the load acting on the bearing arrangement, in particular on the first roller bearing, is not homogenous around the circumference, but is uneven mainly due to the rotor weight causing a static load acting mainly in a radial direction, such that the friction to be overcome is uneven around the circumference. In order to compensate for the uneven load, the resulting force of the pretensioning device is unevenly distributed over the circumference. Thus, an optimized pretension distribution around the circumference of the first roller bearing and thus the bearing arrangement can be achieved. This solution serves to achieve all the benefits of the pretension and in particular contributes to reducing wear and to optimizing the lifetime of the bearing arrangement. This solution allows a resulting force distribution to be adapted according to what is needed to overcome the friction. Thus, the distribution of pretensioning force can be optimized.

The first roller bearing and the second roller bearing can be distant from one another in the axial direction. The first roller bearing is preferably the rear bearing, meaning that the first roller bearing is arranged at a gearbox side, facing the gearbox of the wind turbine. The second bearing includes a second bearing inner ring, a second bearing outer ring, and rolling elements therebetween. The second roller bearing is preferably facing the rotor side.

The pretension circuit means that the two roller bearings, for example, tapered roller bearings, the rotating component and the bearing housing are formed and configured such that these elements can be/are pretensioned against each other.

The stationary component can be named “stator”. Preferably, the stationary component is the bearing housing. For example, the bearing housing is the outer housing, being arranged facing the outside of the bearing arrangement. In other words, the bearing housing is arranged away from the rotational axis.

According to an embodiment, a homogeneous pretension can be adjusted over the circumference of the first rolling bearing by the unevenly distributed resulting force. This contributes to the above functions and advantages and offers a simple way of implementing the disclosure. For example, predicting or calculating the resulting force leading to the homogeneous pretension is easy compared to an inhomogeneous pretension. Further, setting a homogeneous pretension is comparably easy to set or adjust via the pretensioning device.

According to an embodiment, an inhomogeneous pretension can be adjusted over the circumference of the first rolling bearing by the unevenly distributed resulting force. Thus, by providing an uneven resulting force an unevenly distributed pretension is provided, which could be beneficial in certain circumstances. In particular, such an arrangement could provide an optimized pretension distribution for facing situations in which the load acting on the bearing arrangement is such that a specific bearing area may experience a loss of pretension, thus leading to a risk of slippage in the specific bearing area. For example, the inhomogeneous pretension can be adjusted over the circumference of the first rolling bearing by the unevenly distributed resulting force such that the pretension force is higher in the lower bearing area than in the higher bearing area. Thus, the risk of slippage in the lower bearing area can be reduced.

According to an embodiment, upon actuation of the pretensioning device, the first bearing inner ring or the first bearing outer ring is axially moved along the rotational axis with respect to the stationary component, and/or radially deformed with respect to the rotational axis.

For example, the first bearing inner ring or first bearing outer ring is axially moveable along the rotational axis, which means along a direction parallel to the rotational axis. Alternatively or additionally, the first bearing outer ring is deformed in a radial direction with respect to the rotational axis. In any case, the movement or deformation is caused by actuation of the pretensioning device, wherein a mechanical force is transferred onto the first bearing outer ring or first bearing inner ring, either directly or indirectly.

According to an embodiment, the pretensioning device is either force-controlled or displacement-controlled for applying the uneven force. This means that the pretensioning device is either set to exert a non-uniform force around the circumference of the first roller bearing and/or is set to provide a non-uniform displacement of the first bearing inner/outer ring so that the non-uniform load on the bearing is compensated for to realize the pretension target.

According to an embodiment, the pretensioning device is located between the first roller bearing and the second roller bearing with respect to the rotational axis. Thus, the pretensioning device can be easily accessed from outside the bearing housing and it is not necessary to access the pretensioning device from the gearbox side.

According to an embodiment, the pretensioning device includes several single adjustment devices, which are configured to be actuated to commonly cause the resulting force. For example, the adjustment devices are screws, hydraulic cylinders, piezo elements, pneumatic elements or thermocouples. These adjustment devices are arranged along the circumference of the first bearing outer ring or first bearing inner ring, more specifically the outer ring or the inner ring at the gearbox side.

According to an embodiment, the adjustment devices have the same structure but are unevenly distributed around the circumference of the first roller bearing.

According to an embodiment, the adjustment devices are evenly distributed around the circumference of the first roller bearing but are constructed or actuated differently to generate the uneven resulting force.

According to an embodiment, each adjustment device extends through an opening of the stationary component and is accessible from outside the stationary component. The mentioned opening goes through an entire wall (portion) of the bearing housing, for example, in contrast to a blind hole. The opening is configured such that actuation of the adjustment device is possible. In other words, the opening needs to be large enough to allow actuation, that is, movement, of the actuation device. For example, the opening is slit-shaped and runs over at least a portion of the bearing housing circumferentially around the rotational axis.

According to an embodiment, each adjustment device is arranged inside the stationary component.

According to an embodiment, each adjustment device directly acts on the first bearing inner ring or the first bearing outer ring. Thus, no further component(s) is/are arranged between an adjustment device and the respective bearing ring.

According to an embodiment, a ring-shaped force transfer element is provided between the adjustment devices and the first bearing inner ring or the first bearing outer ring, such that a force, which is set or adjusted upon actuation of each adjustment device, can be transferred between the adjustment devices and the first bearing inner ring or the first bearing outer ring. For example, the force transfer element is formed homogenously around the circumference of the first roller bearing.

According to an embodiment, the pretensioning device includes a hydraulic ring piston, which is arranged in the stationary component around the rotational axis and is in direct contact with the first bearing outer ring, wherein the hydraulic ring piston has a different radial extension along the circumference of the first roller bearing with respect to the rotational axis such that a hydraulic force, which is set or adjusted to act on the hydraulic ring piston, is transferred between the hydraulic ring piston and the first bearing outer ring to cause the unevenly distributed resulting force. Thus, for example, the pretension of the bearing arrangement can be adjusted very precisely.

According to an embodiment, the pretensioning device includes several hydraulic ring piston segments, which extend inside the stationary component around the rotational axis to form a common segmented ring and are each in direct contact with the first bearing outer ring, wherein the hydraulic ring piston segments are spaced apart from each other and have a different arcuate extension around the rotational axis, such that a hydraulic force, which is set or adjusted to act on the hydraulic ring piston segments, is transferred between the hydraulic ring piston segments and the first bearing outer ring to cause the unevenly distributed resulting force. The ring piston segments are differently formed with respect to an extension along the circumference of the first roller bearing.

According to an embodiment, the pretensioning device includes a clamping ring, which surrounds the rotating element at an end face thereof in a form-fit manner and which has a radially inwardly extending shoulder which abuts the end face of the rotating element axially with respect to the rotational axis, wherein the clamping ring is screwed to the end face of the rotating element via several adjustment screws in such a way that the clamping ring is pressed against the first bearing inner ring to cause the unevenly distributed resulting force.

Regarding the above embodiments, in particular with regard to the different embodiments of the adjustment devices, applicant refers to two US patent applications, Ser. No. 18/737,792, filed Jun. 7, 2024, and Ser. No. 18/732,228, filed Jun. 3, 2024, which are incorporated herein by reference.

### BRIEF DESCRIPTION OF DRAWINGS

The invention will now be described with reference to the drawings wherein:

FIG. 1 shows a schematic illustration of a wind turbine;

FIG. 2 shows a simplified, partial illustration of a bearing arrangement in a final mounted position with a gearbox connected between the bearing arrangement and a generator according to the prior art; and,

FIGS. 3 to 8 show schematic sectional views of bearing arrangements according to embodiments of the disclosure.

### DETAILED DESCRIPTION

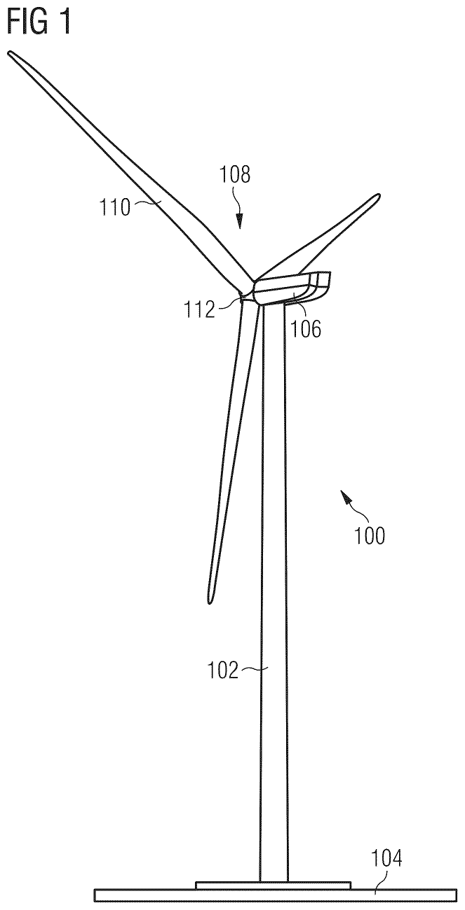

FIG. 1 shows a schematic view of a wind turbine 100, which includes a tower 102. The tower 102 is fixed to the ground via a foundation 104. A nacelle 106 is rotatably mounted at one end of the tower 102 opposite to the ground. The nacelle 106, for example, includes a generator which is coupled to a rotor 108 via a rotor shaft (not shown). The rotor 108 includes one or more (wind turbine) rotor blades 110, which are arranged on a rotor hub 112.

During operation, the rotor 108 is set in rotation by an air flow, for example wind. This rotational movement is transmitted to the generator via the rotor shaft and, if necessary, a gearbox. The generator converts the kinetic energy of the rotor 108 into electrical energy.

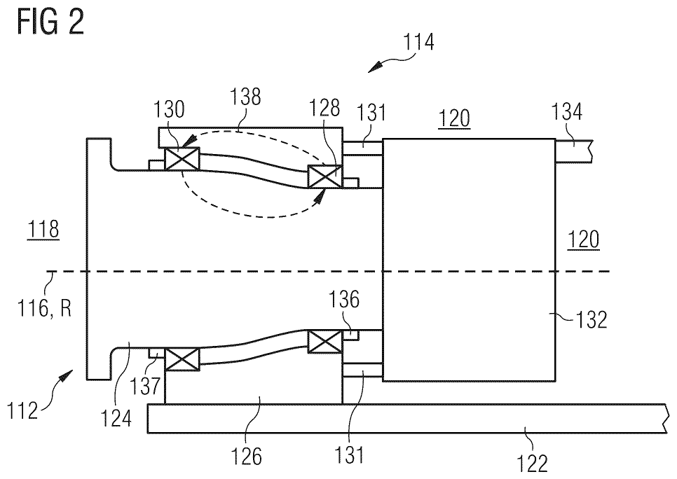

FIG. 2 shows a simplified representation of an embodiment of a bearing arrangement 114 within wind turbine 100. The bearing arrangement 114 extends in the longitudinal axis 116 along an axis of rotation R from a front rotor side 118 to a rear side 120 (gearbox/generator side). The bearing arrangement 114 generally has a rotor shaft 124 as a rotor or rotating component, the rotor shaft 124 being connected to the rotor hub 112 (not illustrated) at the front rotor side 118 of the bearing arrangement 114. Furthermore, the bearing arrangement 114 has a bearing housing 126 as a stationary component, the bearing housing 126 being connected to a machine frame 122. The rotor shaft 124 and the bearing housing 126 are rotatably mounted on one another via two bearings, namely a gearbox-side bearing 128 (first bearing) and a rotor-side bearing 130 (second bearing). Typically, the two bearings are tapered roller bearings.

The rotor shaft 124 rotates in operation about the axis of rotation R (rotational axis), whereas the bearing housing 126 is fixedly connected to the machine frame 122. In the shown embodiment according to FIG. 2 the rotor shaft 124 is connected to a gearbox 132, in particular to a gearbox input shaft (not shown). The bearing housing 126 is connected to the gearbox 132, in particular to a housing of the gearbox 132, via a torque support arrangement 131. The presence of the torque support arrangement between the bearing housing 126 and the gearbox 132 renders access to the bearing arrangement from the gearbox side difficult or impossible. The gearbox 132 is connected to a generator (not shown) via an output shaft 134 of the gearbox 132.

In an alternative non-illustrated embodiment, the bearing housing 126 is connected to a gearbox-generator assembly via a torque support arrangement. The gearbox-generator assembly corresponds in particular to a gearbox in which a generator is integrated. In a further non-illustrated embodiment, the wind turbine 100 does not include any gearbox (direct drive concept), such that the bearing housing 126 is connected to a generator via a torque support arrangement.

Referring again to the embodiment of FIG. 2, at the first bearing 128 at the tapered end of the rotor shaft 124, a pretensioning member configured as a pretension ring 136 is arranged which acts on the respective first bearing 128 in the longitudinal axis 116 with a biasing force, so that the entire bearing arrangement 114 is biased and thus no clearance is provided in both the axial direction and in the radial direction with respect to the axis of rotation R. The pretensioning member may alternatively be configured, for example, as a shaft nut. The pretensioning force generated by the pretension ring 136 is transmitted via the respective first bearing 128 on the bearing housing 126, from there via the opposite second bearing 130 on the rotor shaft 124. The rotor shaft 124 typically includes a shoulder 137 which serves as an axial abutment for the second bearing 130 on the front rotor side 118. The pretensioning force is then transmitted from the rotor shaft 124 back to the first bearing 128. Thus, a pretension circuit 138 is formed by these components, which is exemplified by the dotted lines in FIG. 2.

The bearing arrangement 114 including rotor shaft 124, bearing housing 126, bearings 128, 130 and pretension ring 136 is typically a preassembled unit, which is typically supplied in the assembled state to the site of the wind turbine and is finally mounted there with the rotor hub 112 and the machine frame 122. Alternately, at least part of the components of the bearing arrangement 114 may be separately supplied to the site of the wind turbine and assembled to the remaining components of the bearing arrangement 114 on site.

In the following, embodiments of the disclosure are described which focus on an improved pretensioning mechanism.

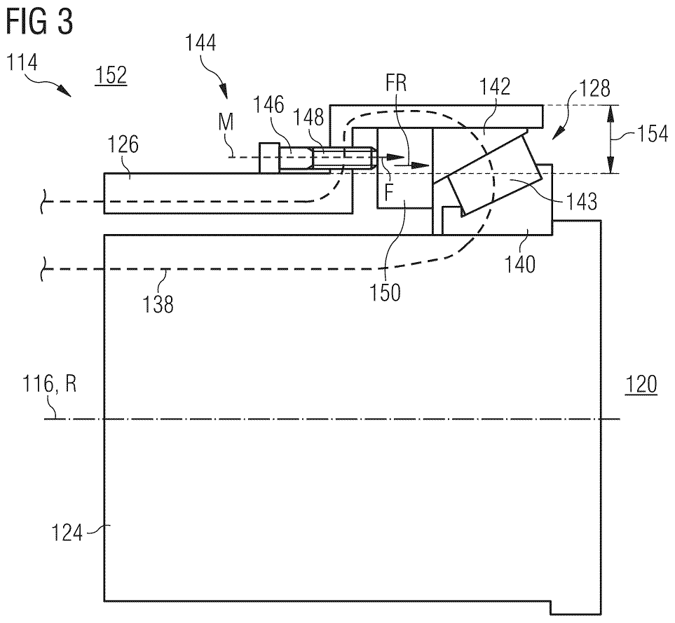

FIG. 3 shows a schematic bearing arrangement 114 according to an embodiment of the disclosure. The bearing arrangement 114 has a bearing housing 126, a rotor shaft 124 (corresponding to a rotating component), a first roller bearing 128 and a second roller bearing 130 (not shown for the sake of overview). The bearing arrangement 114 has a longitudinal axis 116 and the rotor shaft 124 rotates around a rotational axis R. The bearing housing 126 supports the first and the second roller bearings 128 and 130. The first and the second roller bearings 128 and 130 support the rotor shaft 124. The first roller bearing 128 and the second roller bearing 130 are tapered roller bearings and are arranged in the so-called “O”-arrangement. The first roller bearing 128 is arranged at the rear side 120 (generator side or gearbox side). At the rear side 120, the rotor shaft 124 is connected to a gearbox (not shown). The first roller bearing 128 includes a first bearing inner ring 140, a first bearing outer ring 142 and rolling elements 143 arranged and supported between the first bearing inner ring 140 and the first bearing outer ring 142.

In an installed state within the wind turbine 100, the bearing arrangement 114 is operated such that a rotation of the rotor 108 drives the rotor shaft 124. The rotation of the rotor shaft 124 is transferred to the gearbox, via which a generator is driven to generate electrical energy.

The bearing arrangement 114 of FIG. 3 is generally pretensioned as described above and in accordance with FIG. 2, wherein instead of the pretension ring 136 another pretensioning device is used. In this regard, the first roller bearing 128, the second roller bearing 130, the rotor shaft 124 and the bearing housing 126 are configured and arranged to form a pretension circuit 138.

A pretensioning device 144 is provided to set/adjust the pretension of the bearing arrangement 114, that is, to adjust the pretension of the formed pretension circuit 138. The pretensioning device 144 includes several single adjustment devices 146 arranged circumferentially around the first roller bearing 140 with respect to the rotational axis R (only one adjustment device 146 shown). The first bearing outer ring 142 can be axially moved via the adjustment devices 146, that is, in a direction parallel to the rotational axis R. In the shown embodiment, the adjustment devices 146 are screws (also called “pressure screws”). Each screw has an at least partially threaded screw shaft and is screwed into a corresponding opening 148 (here: through-hole) of the bearing housing 126 and is arranged such that it can be moved along a moving direction M wherein, in the present example, the moving direction M runs parallel to the rotational axis R, that is, at an angle of 0° with respect to the rotational axis R.

A force transfer element 150 is arranged between the adjustment devices 146 and the first bearing outer ring 142. The force transfer element 150 is a ring member extending circumferentially around the rotational axis R. For example, the force transfer element 150 is washer-like and can also be called a pressure ring. The force transfer element 150 is axially moveable along the rotational axis R.

In the pretensioned state as shown, the adjustment devices 146 are in direct contact with the force transfer element 150, wherein the latter is in direct contact with the first bearing outer ring 142.

To adjust the pretension of the bearing arrangement 114, the screws 146 are actuated, that is, torque is applied to the screws 146. To increase the pretension, the screws 146 are actuated (turned) such that they are moved (further) against the force transfer element 150 (towards the right in FIG. 3). Thus, a force F of each screw 146 is increased and this force F is transferred to the force transfer element 150. The force transfer element 150 is configured to distribute the load onto the first bearing outer ring 142, such that a resulting force FR acts on the first bearing outer ring 142. This causes axial movement/displacement of the first bearing outer ring 142 and thus impacts the pretension circuit 138. The pretension of the bearing arrangement 114 is thus adjusted.

Similarly, each screw 146 can be actuated such that it is moved away from the first bearing outer ring 142 and the force transfer element 150, meaning that the pretension can be reduced.

As can be seen from FIG. 3, the screws 146 are arranged between the first roller bearing 128 and the second roller bearing. Thus, the screws 146 are easily accessible from outside 152 of the bearing arrangement 114. For adjustment of the pretension, it is thus not necessary to gain access from the rear (gearbox) side 120, which is particularly problematic after the bearing arrangement 114 has been installed in the wind turbine 100 and/or during operation of the wind turbine 100.

In the shown embodiment, the bearing housing 126 includes a step 154 so that the screws 146 can be accommodated. Of course, other configurations of the bearing housing 126 and/or arrangements of the screws 146 are applicable.

With the screws 146, a very precise adjustment of the pretension is possible. Preferably, fine threads are used to allow fine tuning of the pretension, that is, only fractions of a mm.

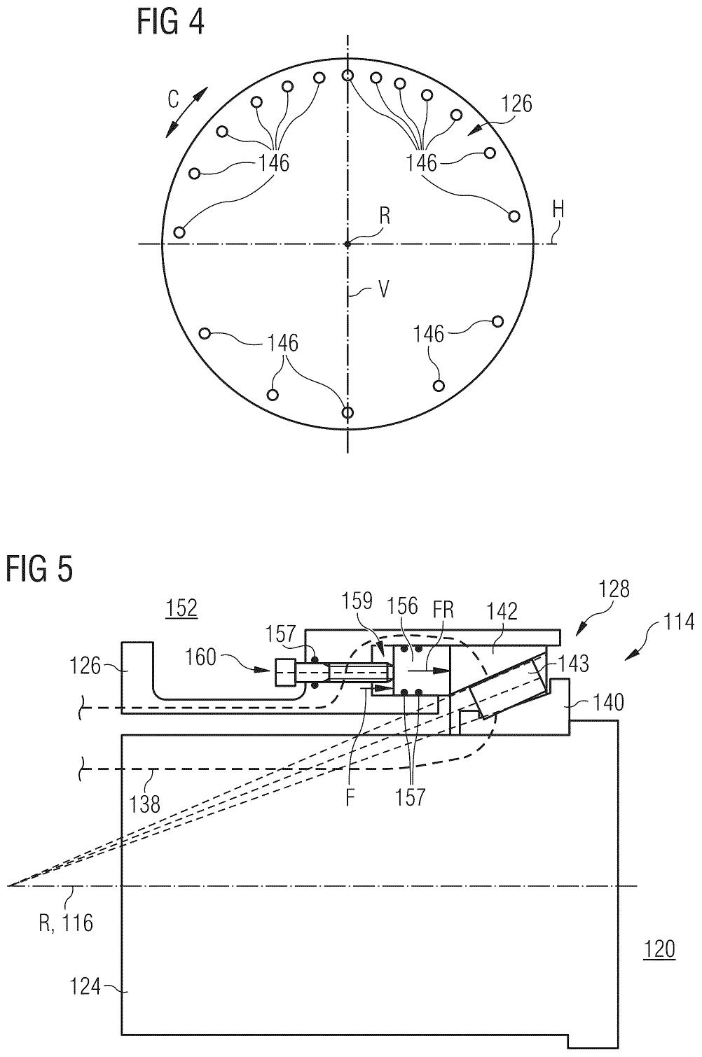

Particularly noteworthy in bearing arrangement 114 is the fact that the pretensioning device 144 is configured such that the resulting force FR caused by the screws 146 is unevenly distributed over the circumference of the first roller bearing 128, as schematically indicated in FIG. 4. FIG. 4 shows a cross-sectional schematic view of the bearing arrangement 114, wherein the cross section runs in normal direction to the rotational axis R. The bearing arrangement 114 as shown represents an intended installation state within the wind turbine 100. Further, a vertical plane V and a horizontal plane H are illustrated. As can be seen, in circumferential direction C several adjustment devices 146 are arranged entering through the bearing housing 126. In the intended installed state of the bearing arrangement 114, more adjustment devices 144 are arranged above the horizontal plane H, in which the rotational axis R runs, than below the horizontal plane H. This configuration allows the resulting force FR to be unevenly distributed in order to compensate for the inhomogeneous loads acting on the bearing arrangement 114, as described in the introductory portion. If each screw 146 is essentially equally actuated, for example, turned, the resulting force FR is unevenly distributed since the screws 146 are unevenly distributed around the circumference. By this measure, the pretension of the bearing arrangement 114 can be evenly distributed over the whole first bearing outer ring 142. In other words, the pretension is homogeneously set/adjusted over the circumference of the first roller bearing 128.

Alternatively, with the described arrangement it is possible that a predetermined uneven pretension is achieved with an unevenly distributed resulting force FR.

In the described embodiment with regard to FIGS. 3 and 4, the adjustment devices 146 have the same structure and are unevenly distributed around the circumference of the first roller bearing. In an alternative example, in order to achieve the uneven distribution of the resulting force FR, the adjustment devices 146 are evenly distributed around the circumference of the first roller bearing 128, but are constructed or actuated differently to generate the uneven resulting force FR.

The pretensioning device 144, that is, the screws 146, can be force-controlled or displacement-controlled.

Instead of acting on the force-transfer element 150, the screws 146 could also act directly on the first bearing outer ring 142.

Alternatively, the pretensioning device 144, for example, the screws 146, could directly or indirectly provide a force F onto the first bearing inner ring 140. For example, a pretension ring (see ring 136 in FIG. 2 as described above) can be used for pretension of the first roller bearing 128.

The adjustment devices 146 can be configured and arranged differently. Further, the transfer of their forces onto the first roller bearing 128 can be carried out differently, for example, via wedged shaped force transfer elements and so on. In this regard, applicant refers to two US patent applications, Ser. No. 18/737,792, filed Jun. 7, 2024, and Ser. No. 18/732,228, filed Jun. 3, 2024, incorporated herein by reference.

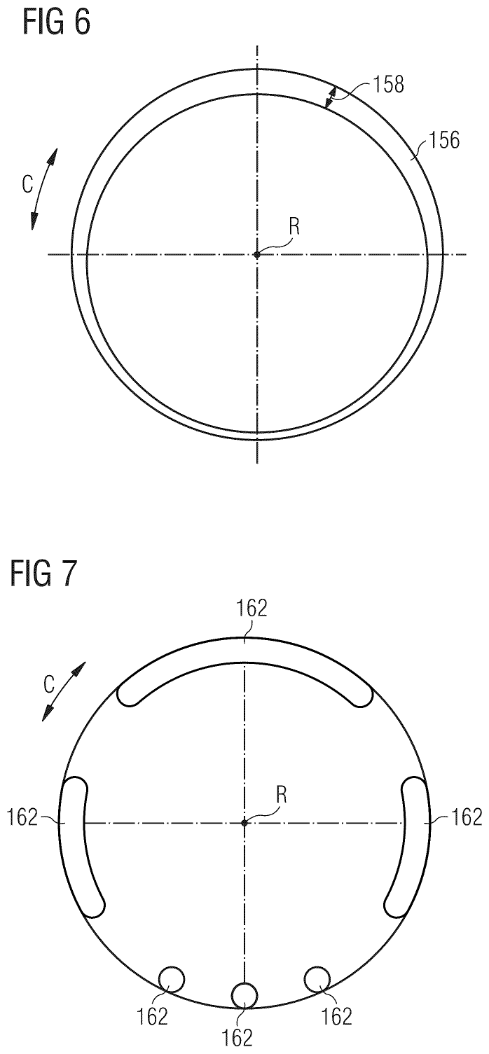

FIGS. 5 and 6 show a further embodiment of the disclosure, which differs regarding the pretensioning device 144 and the adjustment of the pretension. Thus, the above description of the features similarly applies, unless otherwise stated below. For the sake of clarity, however, not all reference signs are necessarily reproduced in the figures and described again.

As a main difference, the pretensioning device 144 includes a hydraulic ring piston 156, which is arranged in the bearing housing 126 around the rotational axis R and is in direct contact with the first bearing outer ring 142. The hydraulic ring piston 156 has a different radial extension 158 (in other words thickness) along the circumferential direction C of the first roller bearing 128 with respect to the rotational axis R. A hydraulic force F can now be applied to the ring piston 156 by a hydraulic system connected to the housing 126 (not shown in FIG. 5). The hydraulic force F is generated by introducing a pressurized hydraulic fluid into a chamber 159 formed by the hollow space between the bearing housing 126 and the ring piston 156. O-ring seals 157 are provided between the ring piston 156 and the bearing housing 126 and between the screws 160 and the bearing housing 126 in order to prevent the hydraulic fluid from leaking out of the chamber 159. This hydraulic force F is transferred between the hydraulic ring piston 156 and the first bearing outer ring 142 and causes the unevenly distributed resulting force FR due to the inhomogeneous radial extension 158. One or more locking screws 160 are provided to hold the hydraulic ring piston in position and thus the pretension of the bearing arrangement 114 is maintained after having applied the hydraulic force F. This allows the hydraulic force to be released afterwards and the hydraulic system to be removed.

FIG. 7 shows a further embodiment of the disclosure, which is similar to the above-described embodiment with respect to FIGS. 5 and 6. Thus, the above description of the features and the shown embodiment of FIG. 5 similarly apply, unless otherwise stated below. As a difference to the above, the pretensioning device 144 includes several hydraulic ring piston segments 162 which extend inside the bearing housing 162 around the rotational axis R to form a common segmented ring and are each in direct contact with the first bearing outer ring 142. The hydraulic ring piston segments are spaced apart from each other in the circumferential direction C and have a different arcuate extension around the rotational axis R. A hydraulic force F, which is set or adjusted to act on the hydraulic ring piston segments 162, is transferred between the hydraulic ring piston segments 162 and the first bearing outer ring 142 to cause the unevenly distributed resulting force FR, in particular due to the differently configured segments 162. Again, locking screws 160 are used to hold the position of the ring segments 162 and thus to maintain the pretension of the bearing arrangement 114.

This embodiment enables higher forces at the same pressure and with the same radial space. An adaptation of necessary force can be achieved by providing different ring piston segments in the circumferential direction C (even ring piston segments can be used being only cylinders, for example, at a bottom side of the first roller bearing 128).

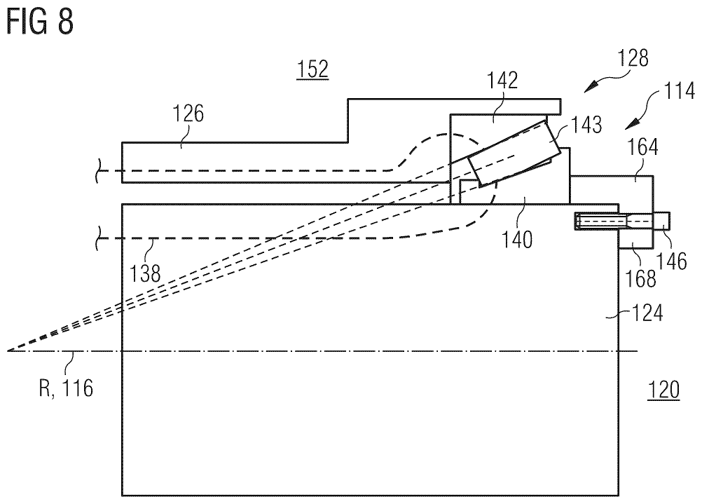

FIG. 8 shows a further embodiment of the disclosure, which differs regarding the pretensioning device 144 and the adjustment of the pretension. Thus, the above description of the features similarly applies, unless otherwise stated below. For the sake of clarity, however, not all reference signs are necessarily reproduced in the figures and described again.

In the embodiment of FIG. 8 the bearing arrangement includes a stationary shaft 124 as a stationary component and a rotating bearing housing 126 as a rotating component. The pretension device 144 is arranged at the stationary shaft 124. Therefore, similarly to the above embodiments, the pretension device 144 is arranged at the stationary component. The pretensioning device 144 includes a clamping ring 164, which surrounds the stationary shaft 124 at an end face 166 thereof in a form-fit manner and which has a radially inwardly extending shoulder 168. The shoulder 168 abuts the end face 166 of the stationary shaft 124 axially with respect to the rotational axis R. The clamping ring 164 is screwed to the end face 166 of the stationary shaft 124 via several adjustment screws 146 in such a way that the clamping ring 164 is pressed against the first bearing inner ring 140 to cause the unevenly distributed resulting force FR.

It is understood that the foregoing description is that of the preferred embodiments of the invention and that various changes and modifications may be made thereto without departing from the spirit and scope of the invention as defined in the appended claims.

### REFERENCE SIGNS

100 wind turbine
102 tower
104 foundation
106 nacelle
108 rotor
110 rotor blade
112 rotor hub
114 bearing arrangement
116 longitudinal direction
118 front rotor side
120 rear side
122 machine frame
124 rotor shaft, stationary shaft
126 bearing housing, rotating bearing housing
128 first bearing
130 second bearing
131 torque support arrangement
132 gearbox
134 output shaft
136 pretension ring
137 shoulder
138 pretension circuit
140 first bearing inner ring
142 first bearing outer ring
143 rolling element
144 pretensioning device
146 adjustment device
148 opening
150 force transfer element
152 outside
154 step
156 hydraulic ring piston
157 O-ring seal
158 radial extension
159 chamber
160 locking screws
162 hydraulic ring piston segments
164 clamping ring
166 end face
168 shoulder
C circumferential direction
F force
H horizontal plane
FR resulting force
M moving direction
R rotational axis
V vertical plane

1. A bearing arrangement for a rotating component of a wind turbine, the bearing arrangement comprising
a first roller bearing and a second roller bearing;
said rotating component defining a rotational axis and being supported by said first roller bearing and said second roller bearing;
a stationary component supporting said first roller bearing and said second roller bearing;
said first roller bearing, said second roller bearing, said rotating component and said stationary component being arranged to conjointly form a pretension circuit;
said first roller bearing including a first bearing inner ring, a first bearing outer ring and rolling elements arranged between said first bearing inner ring and said first bearing outer ring; and,
a pretensioning device being configured, upon actuation, to cause a resulting force to be applied to the first bearing inner ring or the first bearing outer ring to adjust the pretension of the bearing arrangement, wherein the resulting force is unevenly distributed over a circumference of the first roller bearing with respect to the rotational axis.

2. The bearing arrangement of claim 1, wherein said pretensioning device is configured to adjust a homogeneous pretension over the circumference of the first rolling bearing by the unevenly distributed resulting force.

3. The bearing arrangement of claim 1, wherein said pretensioning device is configured to adjust an inhomogeneous pretension over the circumference of the first rolling bearing by the unevenly distributed resulting force.

4. The bearing arrangement of claim 1, wherein, upon actuation of the pretensioning device, said first bearing inner ring or said first bearing outer ring is moved in at least one of the following ways: i) axially along said rotational axis with respect to said stationary component; and, ii) radially deformed with respect to the rotational axis.

5. The bearing arrangement of claim 1, wherein said pretensioning device is either force-controlled or displacement-controlled for applying the uneven force.

6. The bearing arrangement of claim 1, wherein said pretensioning device is located between said first roller bearing and said second roller bearing with respect to said rotational axis.

7. The bearing arrangement of claim 1, wherein said pretensioning device includes several single adjustment devices, which are configured to be actuated to commonly cause said resulting force.

8. The bearing arrangement of claim 7, wherein said adjustment devices have the same structure, but are unevenly distributed around the circumference of said first roller bearing.

9. The bearing arrangement of claim 7, wherein said adjustment devices are evenly distributed around the circumference of the first roller bearing and are configured or actuated differently to generate the uneven resulting force.

10. The bearing arrangement of claim 7, wherein each of said adjustment devices extends through an opening of said stationary component and is accessible from outside said stationary component.

11. The bearing arrangement of claim 7, wherein each of said adjustment devices is arranged inside said stationary component.

12. The bearing arrangement of claim 7, wherein each one of said adjustment devices directly acts on said first bearing inner ring or said first bearing outer ring.

13. The bearing arrangement of claim 7, further comprising a ring-shaped force transfer element provided between said adjustment devices and said first bearing inner ring or said first bearing outer ring, such that a force, which is set or adjusted upon actuation of each adjustment device, can be transferred between said adjustment devices and said first bearing inner ring or said first bearing outer ring.

14. The bearing arrangement of claim 1, wherein said pretensioning device includes a hydraulic ring piston arranged in said stationary component around said rotational axis and is in direct contact with said first bearing outer ring; and, said hydraulic ring piston has a different radial extension along the circumference of said first roller bearing with respect to said rotational axis, such that a hydraulic force, which is set or adjusted to act on the hydraulic ring piston, is transferred between said hydraulic ring piston and said first bearing outer ring to cause the unevenly distributed resulting force.

15. The bearing arrangement of claim 1, wherein said pretensioning device includes several hydraulic ring piston segments which extend inside said stationary component around the rotational axis to form a common segmented ring and are each in direct contact with said first bearing outer ring; said hydraulic ring piston segments are spaced apart from each other and have a different arcuate extension around the rotational axis, such that a hydraulic force, which is set or adjusted to act on the hydraulic ring piston segments, is transferred between said hydraulic ring piston segments and said first bearing outer ring to cause the unevenly distributed resulting force.

16. The bearing arrangement of claim 1, wherein said bearing arrangement is a rotor bearing arrangement and said stationary component is a bearing housing.
